(19) United States
(12) Patent Application Publication
(10) Pub. No.: US 2010/0151106 A1
(43) Pub. Date: Jun. 17, 2010

(54) Food Composition Containing Polyphenols

(75) Inventor: Shiping Zhu, Sharnbrook (GB)

Correspondence Address: UNILEVER PATENT GROUP, 800 SYLVAN AVENUE, AG West S. Wing, ENGLEWOOD CLIFFS, NJ, 07632-3100, US

(73) Assignee: CONOPCO, INC., D/B/A UNILEVER, Englewood Cliffs, NJ (US)

(21) Appl. No.: 12/637,076

(22) Filed: Dec. 14, 2009

(30) Foreign Application Priority Data
Dec. 16, 2008 (EP) EP08171872

(51) Int. Cl. A23C 9/123; A23L 2/00; A23D 9/00

(52) U.S. Cl. 426/583; 426/531; 426/590; 426/601

(57) ABSTRACT

Food composition having a pH of between 3.5 and 6.5 containing at least 100 mg/l, preferably at least 300 mg/l of a (catechins-Al⁺⁺⁺ salt) precipitate

### Technical Field of the Invention

The present invention relates to food composition containing polyphenols.

### BACKGROUND OF THE INVENTION

Polyphenols are water soluble molecules known to have antioxidant properties as well as providing other health benefits. Extensive research has particularly taken place on tea polyphenols, more particularly catechins and even more particularly Epi Gallo Catechin Gallate (EGCG).

It more particularly been proposed to increase the catechin level of ready to drink tea beverages.

However, polyphenols are not stable in water due to oxidation and are known to be bitter and/or astringent. It is therefore a challenge to incorporate them in food compositions and particularly in beverages in an effective amount without adversely affecting the taste.

A solution to avoid the bitter taste of polyphenols is encapsulation of the polyphenols to prevent the contact of the ingredient with the mouth. A drawback of the encapsulation is that a suitable encapsulate should be found that works well in the food product. Furthermore encapsulates are often more expensive than the bare ingredient it self. Encapsulation has been proposed in U.S. Pat. No. 6,190,591 to provide delayed release of compounds. JP2005-1245540 provides a method for masking the astringency and bitterness of polyphenols by inclusion of casein. However, encapsulating water soluble compounds such as catechin is faced with an almost impossible to solve dilemma. Water soluble compounds are very difficult to encapsulate, they always tend to leak out at some point in time, leading to shelf life problems. If encapsulation is used which passes the test of time, it then means that the encapsulation is very difficult to reverse, i.e. it becomes a problem in itself to have the encapsulated water soluble product becoming bio available once ingested.

Another way of masking the bitter taste of polyphenols is to add another taste that overtakes the taste of the polyphenols. The addition of milk to tea is used to soften the bitter taste of tea. However often a lot of the masking taste should be added to mask the undesired taste and not much flexibility in taste is left, and another strong taste is left, which leaves out neutral tasting food products.

It has now been found that it is possible to introduce catechin, and in particular EGCG in a food product, and particularly a beverage, to a level in such a way that the bitterness is no longer significant whereas catechin is bio-available once it reaches the stomach.

Tests and Definitions

Polyphenols means catechins, polymeric polyphenol compounds and any mixture thereof.

Catechins means catechin, gallocatechin, catechin gallate, gallocatechin gallate, epicatechin, epigallocatechin, epicatechin gallate, epigallocatechin gallate, and mixtures thereof.

### Polymeric Polyphenol Compounds

The polymeric polyphenol compound suitable in the present invention are defined as compounds containing multiple hydroxyl groups attached to aromatic groups and having a molecular weight equal to or above 500 gram per mole. In the context of the present invention, the term polymeric polyphenol compound comprises oligomeric and polymeric polyphenol compounds. Preferably the molecular weight of the polymeric polyphenol compound is above 700 gram per mole, more preferred above 1000 gram per mole, most preferred above 1500 gram per mole.

The term ‘aromatic group’ includes aromatic hydrocarbon groups and/or heterocyclic aromatic groups. Heterocyclic aromatic groups include those containing oxygen, nitrogen, or sulphur (such as those groups derived from furan, pyrazole or thiazole). Aromatic groups can be monocyclic (for example as in benzene), bicyclic (for example as in naphthalene), or polycyclic (for example as in anthracene). Monocyclic aromatic groups include five-membered rings (such as those derived from pyrrole) or six-membered rings (such as those derived from pyridine). The aromatic groups may comprise fused aromatic groups comprising rings that share their connecting bonds. The term polyphenol also includes glycosidic polyphenols and/or their derivatives (e.g. acids, esters, and/or ethers). Any combinations of the free and various esterified, etherified and glycosylated forms of polyphenols are also included.

The polyphenol may be of natural origin (e.g. from tea, wine or chocolate), of synthetic origin, or mixtures thereof. With the term polymeric polyphenol compounds we include as examples for application in the present invention: tannic acid, condensed tannins, hydrolysable tannins, lignins, flavonoids, proanthocyanidins (or leucoanthocyanidins), procyanidins, theaflavins, thearubigins, tea polyphenols (e.g. theasinensin, galloyl oolongtheanin, theaflavates and bistheaflavates), cocoa and wine polyphenols.

The following examples of compounds may conjugate to form molecules having a molecular weight equal to or larger than 500 gram per mole, and therefore may be suitable for use in the present invention. Polymers or oligomers of (mixtures of) dopamine, epinephrine (adrenaline), norepinephrine (noradrenaline), salbutamol, curcumin and/or its derivatives, rosmarinic acid and/or its derivatives, paradol and its derivatives, hydroxytyrosol, silymarin, coumarin and/or its derivatives, esculetin, scopoletin, lignans (including sesamol, sesamin, sesamolin or mixtures thereof), carnosol, oleuropein, ubiquinol, phenolphthalein, carthamin, polyporic acid, atromentin, bovichinon-3, grevillin A, grevillin B, grevillin D, alkannin, shikonin, alizarin, purpurin, pseudopurpurin, rubiadin, munjistin, chinizarin, morindon, emodin, aloe-emodin, chrysophanol, kermesic acid, carminic acid, ellagic acid, spinochrome, alkannin, hypericin, chrysophanic acid, betanidin, isobetanidin, caftaric acid, chlorogenic acid, syringic acid, gentisic acid, caffeic acid, hops acids (including humulone, lupulone, colupulone or mixtures thereof), magnolol, honokiol, biphenols, di-resorcinol sulphide, bithionol, bromochlorophen, dioxybenzone, bisoctrizole, bemotrizinol, flavones (such as apigenin, luteolin, baicalin), flavonols (such as quercetin, galantin, kaempferol, myricetin, fisetin, isorhamnetin, pachypodol, rhamnazin, rutin, hydroxyethylrutosides), flavanones (such as hesperetin, naringenin, eriodictyol), 3-hydroxyflavanones (such as dihydroquercetin, dihydrokaempferol), isoflavones (such as genistein, daidzein, glycitein), cyanidin, delphinidin, malvidin, pelargonidin, peonidin, petunidin, resveratrol, phenylpropanoids, anthocyanidins, anthocyanins, sanguiin, rhoipteleanin, psiguavin, jolkininin, yunnaneic acid, dehydrotheasinensin, theasinensin quinone, epitheaflagallin, hydroxytheaflavin, proepitheaflagallin, biflavonoids.

Synthetic polyphenols include linear (open chain) and cyclic polyphenols and oligomers (see for example, Handique J G, Baruah J B, ‘Polyphenolic compounds: an overview’, React. & Funct. Polym., 2002, 52(3), p. 163-188).

The term ‘tannin’ is widely applied to any large polyphenolic compound containing hydroxyl and other groups to form strong complexes with proteins and other macromolecules. Tannins have molecular weights ranging from 500 to over 3,000 gram per mole. Tannins degrade by action of alkaline, gelatin, heavy metals, iron, lime water, metallic salts, strong oxidizing agents and zinc sulfate. Tannins are astringent, bitter plant polyphenols that either bind and precipitate or shrink proteins. The astringency from the tannins is what causes the dry and puckery feeling in the mouth following the consumption of red wine, strong tea, or an unripened fruit.

Tannins can be separated into 2 different classes: hydrolysable tannins or condensed tannins, which both are within the scope of the present invention.

Hydrolysable tannic acids release gallic acid upon chemical or enzymatic hydrolysis. Examples of gallotannins are the gallic acid esters of glucose in tannic acid (C₇₆H₅₂O₄₆), found in the leaves and bark of many plant species. Tannic acid is a polyphenolic compound, which is abundantly present in nature, for example in the bark of Sequioa trees, where it prevents these trees from wildfires. The chemical formula for commercial tannic acid is usually given as C₇₆H₅₂O₄₆, however usually tannic acid is a mixture of related compounds. Its structure is based mainly on glucose esters of gallic acid. Tannic acid is highly soluble in water. Gallic acid is 3,4,5-trihydroxybenzoic acid (C₆H₂(OH)₃COOH), found in for example tea leaves.

Tannic acid (C₇₆H₅₂O₄₆, M_{W}=1701.20, synonyms: gallotannin, tannin)

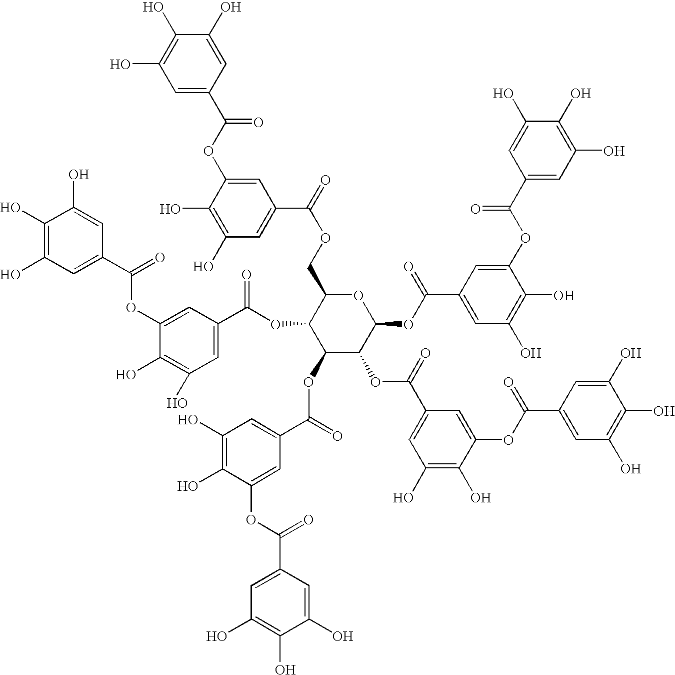

Tannic acid is an especially preferred polymeric polyphenol compound in the context of the present invention.

Condensed tannins (or proanthocyanidins) are polymers of 2 to 50 (or more) flavanoid units that are joined by carbon-carbon bonds, which are not susceptible to being cleaved by hydrolysis. They have been shown to bind to proteins and e.g. by binding to digestive enzymes resulting in a line of defence of plants against herbivores. While hydrolyzable tannins and most condensed tannins are water soluble, some very large condensed tannins are insoluble.

Proanthocyanidins having a molecular weight above 500 gram per mole occur in many sizes, and may be joined at various carbon atoms. Two examples of condensed tannins (proanthocyanidins) are:

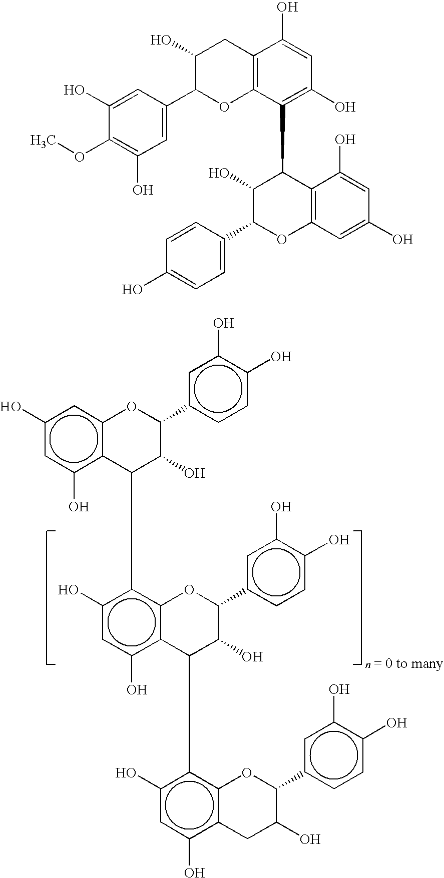

Also higher and more complicated oligomers and polymers are known

“Food Products” means products and ingredients therefore, taken by the mouth, the constituents of which are active in and/or absorbed by the G.I. tract with the purpose of nourishment of the body and its tissues, refreshment and indulgence, which products are to be marketed and sold to customers for consumption by humans. Examples of Food and Beverage Products are tea, including precursors thereof; spreads; ice cream; frozen fruits and vegetables; snacks including diet foods and beverages; condiments; and culinary aids. Food Products may particularly bring any of the following benefits: healthy metabolism; life span extension; optimal growth and development; optimal G.I. tract function; avoidance of metabolic syndrome and insulin resistance; avoidance of dyslipidemias; weight control; healthy mineral metabolism; immune health; optimal eye health; avoidance of cognitive impairment and memory loss; hair and skin health; beauty; and excellent taste and smell.

Spreads

Spreads are oil and water containing emulsion, for instance a margarine type spread. Oil and water emulsion is herein defined as an emulsion comprising oil and water and includes oil in water (O/W) emulsions and water in oil emulsions (W/O) and more complex emulsions for instance water-in-oil-in-water (W/O/W/) emulsions. Oil is herein defined as including fat. Preferably the food product is a spread, frozen confection, or sauce. Preferably a spread according to the invention comprises 20-85 wt. % vegetable oil. Advantageously a spread has a pH of 4.2-6.0. The pH can be measured by melting the spread, separating the molten fat phase from the water phase and measuring the pH of the water phase.

Spreads of the invention may comprise other ingredients commonly used for spreads, such as flavouring ingredients, thickeners, gellation agents, colouring agents, vitamins, emulsifiers, pH regulators, stabilizers etc. Common amounts of such ingredients as well as suitable ways to prepare margarines or spreads are well-known to the skilled person.

Dairy Type Products

Examples of dairy products according to the invention are milk, dairy spreads, cream cheese, milk type drinks and yoghurt. For the purpose of the invention soy milk based drinks are also considered as dairy products according to the invention, although for some applications the use of animal derived dairy bases such as cow milk or cow milk derived yoghurt is preferred.

The food product may be used as such as a milk or yoghurt type drink. Alternatively flavour or other additives may be added.

An example of a composition for a yoghurt type product is about 50-80 wt. % water, 0-15 wt. % whey powder, 0-15 wt. % sugar (e.g. sucrose), 0.01-1 wt. % yoghurt culture, 0-20 wt. % fruit, 0.05-5 wt. % vitamins and minerals, 0-2 wt. % flavour, 0-5 wt. % stabilizer (thickener or gelling agent). To the yoghurt, fruit may be added.

A typical serving size for a yoghurt type product could be from 50 to 250 g, generally from 80 to 200 g.

Frozen Confectionery Products

For the purpose of the invention the term frozen confectionery product includes milk containing frozen confections such as ice-cream, frozen yoghurt, sherbet, sorbet, ice milk and frozen custard, water-ices, granitas and frozen fruit purees.

Preferably the level of solids in the frozen confection (e.g. sugar, fat, flavouring etc.) is more than 3 wt. %, more preferred from 10 to 70 wt. %, for example 40 to 70 wt %.

Ice cream will typically comprise 0 to 20 wt. % of fat, sweeteners, 0 to 10 wt. % of non-fat milk components and optional components such as emulsifiers, stabilisers, preservatives, flavouring ingredients, vitamins, minerals, etc, the balance being water. Typically ice cream will be aerated e.g. to an overrun of 20 to 400%, more specific 40 to 200% and frozen to a temperature of from −2 to −200° C. more specific −10 to −30° C. Ice cream normally comprises calcium at a level of about 0.1 wt %.

Fruit Juice Products

Examples of fruit juice products according to the invention are juices derived from citrus fruit like orange and grapefruit, tropical fruits, banana, peach, peer, strawberry. Fruit juice products may advantageously comprise a liquid protein base such a soy milk, cow milk or yoghurt, whereby typically the amount of fruit juice can be from 1 to 99 wt %, advantageously from 2 to 15 wt %.

General Description of the Invention

It is the object of the present invention to provide a food product characterised in that it contains at least 100 mg/l, preferably at least 300 mg/l, more preferably at least 600 mg/l, even more preferably 900 mg/l of a precipitate selected from the group consisting in (Catechins-Al⁺⁺ salt) precipitate, a (Polymeric polyphenol compounds—Al⁺⁺⁺ salt) precipitate, and any mixture thereof.

Preferably, the food product has a pH of between 3.5 and 6.5. In another preferred embodiment of the invention, the food product contains less than 10% w/w water, preferably less than 5% w/w.

Preferably, the food product according to the present invention contains less than 100 g/l, more preferably less than 50 g/l, even more preferably less than 10 g/l of a precipitate selected from the group consisting in (Catechins-Al⁺⁺⁺ salt) precipitate, a(Polymeric polyphenol compounds—Al⁺⁺⁺ salt) precipitate, and any mixture thereof.

Preferably the catechins are gallated catechins, more preferably EGCG. It has been found that gallated catechisn, preferentially to non gallated catechins, form a precipate with a Al⁺⁺⁺ salt.

Preferably, the precipitate contains between 30% and 90% w/w EGCG, more preferably between 65% and 70% w/w EGCG.

Preferably also, the Al⁺⁺⁺ salt is KAI(SO₄)₂

Preferably the food product is selected within the group consisting in fat spreads, beverages and dairy products.

Preferably also the pH of the food product is between 4 and 6.

More preferably, the food product is a dairy product, more preferably a yoghurt. Even more preferably, the food product contains at least 1 g of (Catechins-salt) precipitate, (Polymeric polyphenol compounds—Al⁺⁺⁺ salt) precipitate, and any mixture thereof per litre of food product, even more preferably at least 5 g per litre of food product.

In another more preferred embodiment, the food product is a fat spread. Even more preferably, the food product contains at least 1 g of (Catechins-Al⁺⁺⁺ salt) precipitate, (Polymeric polyphenol compounds—Al⁺⁺⁺ salt) precipitate, and any mixture thereof per litre of food product, even more preferably at least 5 g.

Spreads of the inventions are preferably vegetable oil based spreads of the water in oil type. Such spreads are for example used as low or full-fat margarine type product, for example for the flavouring of food products or the spreading on for example sandwiches and toasts. Vegetable oil based spreads may sometimes also be used for baking or frying purposes. In addition of water and vegetable oil spreads of the invention may comprise various ingredients and flavouring ingredients for example as described here below.

The spreads of the invention may optionally comprise thickeners. For stability reasons it may be useful to include thickeners in the emulsion, for example in low fat spreads containing 20 to 40 wt % of fats, often improve by addition of thickeners. Whether or not a thickener should be added and in what amount depends on factors as stability and application and may be determined by the skilled person.

Suitable thickeners may be any known thickener and are preferably selected from the group comprising gums, like xanthan, guar, and locust bean, carrageenan, polysaccharides, alginate, pectin, starch, and gelatin. The level of thickener in compositions of the invention, preferably is from 0.1 to 5 wt %.

In preferred spread products according to the invention, the aqueous phase comprises a fully gelatinised starch selected from any of the main starch groups: wheat, potato, rice, maize, waxy rice or waxy maize.

The amount of starch in the food product according to the invention depends somewhat on the type of chosen starch and is preferably from 0.2 to 5 wt %, more preferred from 0.7 to 3 wt %, most preferred from 1 to 2 wt %.

To ensure homogeneous distribution of the aqueous phase in the continuous fat phase, the droplet size distribution D_{3,3} of the dispersed aqueous phase is preferably less than 8 μm, more preferably from 4 to 8 μm, more preferred even lower than 6 μm. It will be appreciated that the droplet size can be controlled by adjusting the processing conditions in the unit operations: e.g. higher rotational speed in a scraped surface heat exchanger will produce correspondingly smaller water droplet size distributions.

The spreads according to the invention preferably comprise from 20 to 85 wt % of a vegetable fat, preferably from 30 to 80 wt %, most preferably from 35 to 60 wt %. The spreads according to the invention also preferably contain 11 to 79% w/w of water.

The fat can be a single fat or a combination of vegetable fats. The fat or combination of fats is preferably selected such that the solid fat content is below 6% at 35° C., preferably below 5% at 35° C., more preferred below 4% at 35° C., most preferred from 2 to 4% at 35° C. Optionally relatively small amounts of non-vegetable fats, for example animal fats such as butter or marine oils, for example at levels of 0.1 to 25 wt %, more preferred 0.1 to 5 wt % may advantageously be present in the spreads of the invention.

Suitable vegetable fats can for example be selected from the group comprising bean oil, sunflower oil, palm kernel oil, coconut oil, palm oil, rapeseed oil, cotton seed oil, maize oil, or their fractions, or a combination thereof. Inter esterified fat blends of these fats or optionally with other fats are also encompassed in the invention.

Advantageously, marine oils such as fish oil and or algae oil may be added for the addition of omega-3 and omega-6 fatty acids.

Preferably spreads according to the invention comprise an emulsifier such as polyglycerol polyricinoleate, distilled monoglycerides, citric acid esters of monoglycerides, di-acetyl acetic acid esters of monoglycerides, lactic acid esters of monoglyceride, mono-diglycerides, polyglycerol esters of fatty acids or sorbitan esters of fatty acids.

The most preferred emulsifiers are polyglycerol polyricinoleate and monoglycerides. Even more preferred are combinations of a monoglyceride comprising a saturated fatty acid residue and a monoglyceride comprising an unsaturated fatty acid residue.

The amount of emulsifier depends on the type and effectiveness of the emulsifier selected and can be determined by the person skilled in the art. As a general guidance the amount of emulsifier is preferably from 0.05 to 1.5 wt %, more preferred from 0.1 to 0.7 wt %, most preferred from 0.15 to 0.5 wt %.

The pH of the aqueous phase of the spread can be set to the desired value, among others to influence acidic or basic taste impression and to influence microbial stability. Preferably the pH of the aqueous phase in food products according to the invention is from 4.2 to 6, preferably from 4.3 to 5.5.

Optionally some protein may be added to the spread according to the invention. Protein may be added to beneficially influence the taste, flavour and nutritional value of the food product and also may be added to increase browning of food stuff when the current composition is used as a medium for shallow frying. Generally the level of protein may for example be from 0.1 to 10 wt %.

The spreads according to the invention optionally contain other ingredients such as preservatives, vitamins, taste and flavour components, colorants such as beta-carotene, anti-oxidants.

In yet another more preferred embodiment, the food product is a beverage, even more preferably a tea beverage. In an other more preferred embodiment the beverage is a fruit juice. Even more preferably, the food product contains at least 1 g of (Catechins-Al⁺⁺⁺ salt) precipitate per litre of food product, even more preferably at least 5 g.

### DETAILED DESCRIPTION OF THE INVENTION

The present invention will be further described with reference to the following examples.

### Example 1

EGCG (Teavigo from DSM, Holland) (0.45% w/w) and food grade aluminium potassium sulphate (0.26% w/w) were put in a solution and the pH was allowed to change from 3 to 9 by addition of NaOH.

Up to a pH of 3.5 corresponding to (NaOH/KAl(SO₄)₂) molar ratio of 1.5, the solution was clear. As the molar ratio increased to 2.5 and the pH increased to 4.1, a precipitate appeared (first light then heavy). Then the pH started to increase much quicker as the molar ratio increased.

The precipitate was then separated via centrifuge from the liquid. It was washed twice using water with a pH value of 4.1.

The precipitate was dried to powder via freeze drying or vacuum drier at room temperature. It contained 65% to 70% w/w EGCG. It dissolves easily at low pH (pH 3) and high pH (pH 7). X-ray diffraction data showed that the EGCG inside the precipitate is non-crystalline.

In the pH between the precipitate has low solubility in water as shown in Table 1.

TABLE 1

| Dried | | | | |
|---|---|---|---|---|
| precipitate in | | | EGCG concentration | Percentage of |
| solution | EGCG | | in supernatatant | EGCG dissolved |
| (% w/w) | (% w/w) | pH | (% w/w) | in water |
| 0.5 | 0.33 | 4.6 | 0.039 | 12 |
| 5 | 3.3 | 4.9 | 0.17 | 5.2 |
| 0.5 | 0.33 | 6.5 | 0.045 | 13.8 |

This example shows that at a pH between 4.5 and 6.5, less than 15% of the precipitate is dissolved.

### Example 2.A

40 g of Green tea extract (Sunphenon 90LB, 1.8% w/w) and food grade aluminium potassium sulphate (1.1% w/w) were put in a solution and the pH was allowed to change from 4.1 by addition of NaOH.

The green tea extract had the following composition

Gallocatechin 20.33 mg/g

Epigallocatechin: 127.23 mg/g

Categhin: 11.05 mg/g

Epicatechin: 85.33 mg/g
Total non gallated catechins: 243.93 mg/g

Epigallocatechin gallate: 401.43 mg/g

Gallocatechin gallate 15.54 mg/g

Epicatechin gallate : 73.94 mg/g

Catechin gallate: 1.78 mg/g
Total gallated catechins: 492.69 mg/g
Total catechins: 736.62 mg/g

The precipitate was then separated via centrifuge from the liquid. It was washed twice using water with a pH value of 4.1.

The precipitate was dried to powder via freeze drying or vacuum drier at room temperature. The precipitate had a dry weight of 26.5 g

The precipitate had the following composition.

Gallocatechin 6.34 mg/g

Epigallocatechin: 28.12 mg/g

Categhin: 2.83 mg/g

Epicatechin: 12.85 mg/g
Total non gallated catechins: 50.13 mg/g

Epigallocatechin gallate: 406.75 mg/g

Gallocatechin gallate 17.46 mg/g

Epicatechin gallate : 69.79 mg/g

Catechin gallate: 2.28 mg/g
Total gallated catechins: 496.28 mg/g
Total catechins: 546.42 mg/g

This example shows that gallated catechins are preferentially precipitating.

### Example 2.B

4g of Green tea extract (Sunphenon 90LB, 1.8% w/w) and food grade aluminium potassium sulphate (1.1% w/w) were put in a solution and the pH was allowed to change from 4.4 by addition of NaOH.

The green tea extract had the following composition

Gallocatechin 20.33 mg/g

Epigallocatechin: 127.23 mg/g

Categhin: 11.05 mg/g

Epicatechin: 85.33 mg/g
Total non gallated catechins: 243.93 mg/g

Epigallocatechin gallate: 401.43 mg/g

Gallocatechin gallate 15.54 mg/g

Epicatechin gallate: 73.94 mg/g

Catechin gallate: 1.78 mg/g
Total gallated catechins: 492.69 mg/g
Total catechins: 736.62 mg/g

The precipitate was then separated via centrifuge from the liquid. It was washed twice using water with a pH value of 4.4.

The precipitate was dried to powder via freeze drying or vacuum drier at room temperature. The precipitate had a dry weight of 3.6 g

The precipitate had the following composition.

Gallocatechin 7.23 mg/g

Epigallocatechin: 35.41 mg/g

Categhin: 2.41 mg/g

Epicatechin: 14.46 mg/g
Total non gallated catechins: 59.51 mg/g

Epigallocatechin gallate: 359.20 mg/g

Gallocatechin gallate 14.89 mg/g

Epicatechin gallate: 61.83 mg/g

Catechin gallate: 1.70 mg/g
Total gallated catechins: 437.62 mg/g
Total catechins: 497.13 mg/g

This example shows again that gallated catechins are preferentially precipitating. It also shows that the higher the pH the bigger the precipitation, hence the recovery of catechins and particularly of EGCG.

### Example 3

### A Beverage

0.6% Teavigo and Al precipitate (equivalent to 400 mg EGCG/100 g) obtained according to example 1 is dispersed in water at pH of 5 using a magnetic stirrer. The product was found not be bitter

### Example 4

### A Spread

0.8% Sunphenon 90LB and Al precipitate obtained according to example 2.A was added directly to a commercial spreads. A spatula was used to mix precipitate with the spreads.

8% Sunphenon 90LB and Al precipitate was first dispersed in water. The dispersion was then mixed with a commercial spreads at 1 to 9 weight ratio with a spatula.

The product was found not to be bitter.

### Example 5

### A Yoghurt

0.8% Sunphenon 90LB and Al precipitate obtained according to example 2A was added directly to commercial yoghurt. A spatula was used to mix precipitate with the spreads.

8% Sunphenon 90LB and Al precipitate was first dispersed in water. The dispersion was then mixed with commercial yoghurt at 1 to 9 weight ratio with a spatula.

The product was found not to be bitter.

### Example 6

Aluminium and Grape juice extract complex (MegaNatural Grape juice extract, supplied by Polyphenolics, Inc., Madera, Calif., USA).

The total polyphenol concentration and catechin concentration in the extract are 83.3% and 18% respectively

5 litres of grape juice extract aqueous solution was mixed with 5 litres of Al (Ill) solution using an IKA overhead stirrer and the pH measured. The concentration of Al and total polyphenol in the solution is 0.23M. The pH of the mixture was then adjusted to 4.4 by drop wise addition of 1M Sodium Hydroxide with stirring. Approximately 2.7 Litre of 1M Sodium Hydroxide was required. The precipitate which formed was collected by centrifuging the reaction mixture for 15 mins at 5000 rpm using a Sorvall RC3C centrifuge (H6000A rotor 6×1L). The supernatant was retained for polyphenol and Aluminium analysis. The precipitate was then washed with acidified deionised water (pH4.4) and again recovered by centrifugation. The washing step was repeated twice and then the wet precipitate was frozen in a freezer at −18° C. and freeze dried. 400 g precipitated powder was obtained. The dry precipitate was analysed for polyphenols and aluminium content.

The composition of Al and grape juice extract precipitate

| Total | Total polyphenol | Al | Al | Al to |
|---|---|---|---|---|
| polyphenol | concentration in | concentration in | concentration in | polyphenol ratio |
| content (%) | supernatant (%) | supernatant (%) | precipitate (%) | in precipitate |
| 65.5 | 0.6 | 0.05 | 5.2 | 1.17 |

### Example 7

### Aluminium and Theaflavins Complex

The Theaflavins are extracted from black tea with Theaflavin,Theaflavin3-monogallate, Theaflavin3′-monogallate and Theaflavin digallate. The total Theaflavins concentration is 95%.

200 ml solution of aluminium potassium sulphate and Theaflavines aqueous solution was mixed. The concentration of Al and Theaflavines in the mixed was 0.01M. NaOH solution of 1M was added to the solution to increase the pH to 4.4. The solution was stirred for 2 hrs and the precipitate was separated by centrifuge. The solid was washed with de-ionised water at pH of 4.4 twice. It was then dried by freezing drying. The composition of the precipitate contains 70.9% Theaflavins and 6.4% aluminium.

### Comparative Example 1

As in example 10 of U.S. Pat. No. 4,135,001, an aqueous solution containing 400 mg/l tea extract (Green tea, Sunphenon 90L) and 2 mg/l Al+++ (as aluminium sulfate) was produced. The solution pH was changed from 3.3. to 7.0 and it was observed whether precipitation happened.

Four solutions at pH of 33, 4.4, 5.6 and 7.0 were prepared. No precipitation is noticed for three days.

### Comparative Example 2

As in table 1 of U.S. Pat. No. 5,470,565, a phosphorus buffer solution containing 2500 mg/l tea extract (Green tea, Sunphenon 90L) and 50mg/l Al(NO3)3 was produced. The pH of the buffer solution was 5.6
a. 500 ml phosphorous buffer solution with 5000 mg/l Sunphenon was prepared
b. 500 ml phosphorous buffer solution with 100 mg/l Al(NO3)3 was prepared
c. Mixing a and b together and stirring overnight
d. Mixture filtrated using a filter paper.
The weight of the filter paper after drying at room temperature in a vacuum increases by 65 mg

### Comparative Example 3

As in table 1 of U.S. Pat. No. 5,470,565, a phosphorus buffer solution containing 2500 mg/l tea extract (Green tea, Sunphenon 90L) and 50mg/l Al(NO3)3 and 25 mg/l NaF was produced. The pH of the buffer solution was 5.6
a. 500 ml phosphorous buffer solution with 5000 mg/l Sunphenon was prepared
b. 500 ml phosphorous buffer solution with 100 mg/l Al(NO3)3 and 50 mg/l NaF was prepared
c. Mixing a and b together and stirring overnight
d. Mixture filtrated using a filter paper.
The weight of the filter paper after drying at room temperature in a vacuum increases by 27 mg.

1. Food composition characterised in that it contains at least 100 mg/l, preferably at least 300 mg/l, more preferably at least 600 mg/l, even of a precipitate selected from the group consisting in (Catechins-Al⁺⁺⁺ salt) precipitate, (Polymeric polyphenol compounds—Al⁺⁺⁺ salt) precipitate, and any mixture thereof.

2. Food composition according to claim 1 characterised in that it has a pH of between 3.5 and 6.5

3. Food composition according to claim 2 characterise in that it is selected within the group consisting in fat spreads, beverages and yoghurts.

4. Food composition according to claim 3 characterised in that the food product is a dairy product.

5. Food composition according to claim 3 characterised in that the food product is a fat spread.

6. Food composition according to claim 3 characterised in that the food product is a beverage.

7. Food composition according to any preceding claim characterised in that catechin are gallated catechins.

8. Food composition according to claim 7 characterised in that catechin is EGCG.

9. Food composition according to claim 8 wherein the precipitate contains between 30% and 90% w/w EGCG, preferably between 65% and 70% w/w EGCG.

10. Food composition according to any preceding claim wherein the Al⁺⁺⁺ salt is KAl(SO₄)₂
